(19) United States
(12) Patent Application Publication
(10) Pub. No.: US 2026/0168558 A1
(43) Pub. Date: Jun. 18, 2026

(54) DAMPING FORCE VARIABLE VALVE ASSEMBLY AND DAMPING FORCE VARIABLE SHOCK ABSORBER INCLUDING THE SAME

(71) Applicant: HL MANDO CORPORATION, Pyeongtaek-si (KR)

(72) Inventors: Doobyung KIM, Pyeongtaek-si (KR); Youngjae KIM, Pyeongtaek-si (KR); Byeongsang SON, Pyeongtaek-si (KR)

(73) Assignee: HL MANDO CORPORATION, Pyeongtaek-si (KR)

(21) Appl. No.: 19/425,006

(22) Filed: Dec. 18, 2025

(30) Foreign Application Priority Data
Dec. 18, 2024 (KR) 10-2024-0189940

(51) Int. Cl. F16F 9/46; F16F 9/348

(52) U.S. Cl. CPC F16F 9/46; F16F 9/348

(57) ABSTRACT

A damping force variable valve assembly and a damping force variable shock absorber including the same are disclosed. The damping force variable valve assembly according to some embodiments has an integral soft valve port having a main body portion having a fitting hole formed to penetrate a central portion of the main body portion, and having a connection passage formed outside the fitting hole, and a sub-body portion formed to extend laterally from a rear circumference of the main body portion, a protrusion being formed on a rear surface of the sub-body portion to come into close contact with a front surface of the valve disk. The connection passage comprises a first region having a relatively small transverse cross-sectional area and a second region having a relatively larger transverse cross-sectional area than the first region and located rearward of the first region.

### CROSS-REFERENCE TO RELATED APPLICATION

This application claims priority to and the benefit of Korean Patent Application No. 10-2024-0189940, filed on Dec. 18, 2024, the disclosure of which is incorporated herein by reference in its entirety.

### BACKGROUND

### 1. Technical Field

The present disclosure relates to a damping force variable valve assembly and a damping force variable shock absorber including the same, and more particularly, to a damping force variable valve assembly that allows ease of assembly and enables a reduction in overall size, and to a damping force variable shock absorber including the same.

### 2. Discussion of Related Art

Shock absorbers are generally installed in vehicles such as automobiles and motorcycles to absorb and cushion vibrations or impacts transmitted from a road surface during driving, thereby improving ride comfort.

A shock absorber typically includes a piston rod installed in a cylinder to perform compression and extension strokes, and a piston valve located inside the cylinder in a state coupled to the piston rod to generate damping force.

When the damping force is set to a low level, a shock absorber can absorb vibrations caused by irregularities on a road surface to improve ride comfort, and, on the other hand, when the damping force is set to a high level, changes in vehicle posture can be restrained so that handling stability is improved.

Recently, damping force variable shock absorbers capable of setting different damping characteristics according to the intended use of a vehicle have been applied to vehicles.

Such a damping force variable shock absorber further includes a damping force variable valve assembly for adjusting damping force, and the damping force variable valve assembly can switch the damping force between a hard mode in which a spool of a solenoid closes an auxiliary flow path to generate a high damping force and a soft mode in which the spool opens the auxiliary flow path to generate a low damping force.

FIG. 1 illustrates a damping force variable shock absorber according to related art.

A damping force variable shock absorber according to related art may include a shock absorber body 1 and a damping force variable valve 200. The shock absorber body 1 includes a cylinder 10 having an outer tube 11 and an inner tube 12, a piston rod 13, a piston valve 14, a reservoir chamber 15, and a separator tube 16.

A damping force variable valve assembly 100 is mounted on an outer side of the outer tube 11, and the inner tube 12 is installed inside the outer tube 11 to maintain a predetermined spacing.

In addition, the reservoir chamber 15 for forming a low-pressure chamber PL and a high-pressure chamber PH is formed between the outer tube 11 and the inner tube 12.

The piston rod 13 reciprocates in compression and extension stroke directions in a state in which one end thereof is coupled to the piston valve 14 located inside the inner tube 12.

The piston valve 14, in a state in which one end of the piston rod 13 is coupled thereto, divides the inner tube 12 in a longitudinal direction into a compression chamber 12a and an extension chamber 12b and generates a damping force by reciprocating in the compression and extension stroke directions inside the cylinder 10 so as to create resistance of fluid.

The reservoir chamber 15 is provided in a space between the outer tube 11 and the inner tube 12.

The separator tube 16 is provided between the outer tube 11 and the inner tube 12, and more specifically on an outer surface of the inner tube 12, so that a high-pressure chamber PH is formed on an inner side thereof and a low-pressure chamber PL is formed on an outer side thereof.

That is, the separator tube 16 partitions the inside of the reservoir chamber 15 into the low-pressure chamber PL and the high-pressure chamber PH.

A body valve 17 is installed at a lower end of the inner tube 12 and generates damping force by controlling a flow of working fluid between the reservoir chamber 15 and the compression chamber 12a.

Meanwhile, the high-pressure chamber PH is connected to the extension chamber 12b through an internal hole 12c provided in the inner tube 12, and the low-pressure chamber PL is connected to the compression chamber 12a through a lower flow path formed between the body valve 17 and the outer tube 11 and through a flow path (not shown) formed in the body valve 17.

The damping force variable valve assembly 100 is coupled to the shock absorber body 1. Working fluid can be introduced from the shock absorber body 1.

FIG. 2 is a view illustrating a structure of a damping force variable valve assembly employed in the damping force variable shock absorber of FIG. 1, FIG. 3 is an enlarged view illustrating a port and a soft valve of FIG. 2, and FIG. 4 is a view illustrating a state in which a valve mount is removed from FIG. 3.

Hereinafter, when viewed from FIG. 2, a shock absorber body 1 to which the damping force variable valve assembly 100 is coupled is located above, and a direction toward the shock absorber body 1 is defined as a front side of the damping force variable valve assembly 100.

The damping force variable valve assembly 100 according to related art may include a port 110, a valve housing 120, a soft valve 130, a main valve 140, a safety valve 150, and a solenoid 160.

The front end of the port 110 is connected to the high-pressure chamber PH through the outer tube 11 and the separator tube 16, and a connection passage 111 is formed to penetrate in a front-rear direction inside the port 110 so that working fluid from the high-pressure chamber PH can be introduced into the variable valve assembly.

That is, an inlet of the connection passage 111 is connected to the high-pressure chamber PH, and an outlet of the connection passage 111 is connected to a pilot chamber 123 and a poppet chamber 125 of the valve housing 120.

A washer 113 for fastening may be provided on an outer side of the port 110.

A support portion 115 protruding laterally is formed on a rear side portion of the port 110, and a projection that contacts a front surface of a soft valve body 131 is formed on a rear surface of the support portion 115.

Such a projection seals between the port 110 and the soft valve body 131.

The valve housing 120 is formed of a cylindrical metal material, and the soft valve 130, the main valve 140, and the safety valve 150 may be sequentially assembled into an inner hollow space thereof.

The inner hollow space of the valve housing 120 may be partitioned by a plate-shaped valve base 121.

The valve housing 120 has a pilot chamber 123 provided at a front side thereof and a poppet chamber 125 provided at a rear side thereof with respect to the valve base 121, and the two chambers 123 and 125 may communicate with each other through a base hole 122 formed in the valve base 121.

The pilot chamber 123 forms a relatively larger space than the poppet chamber 125.

The pilot chamber 123 forms a plurality of stepped portions along a longitudinal direction on an inner surface of the hollow space, and a soft valve 130 and a main valve 140 are sequentially provided on the respective stepped portions from an inlet side of the port.

A plurality of flow holes 126 for forming a main flow path are provided in a circumferential direction at an intermediate height of the valve housing 120 where the main valve 140 is located, thereby allowing the inside and outside of the valve housing 120 to communicate with each other.

The poppet chamber 125 is formed to have a smaller volume than the pilot chamber 123, and the safety valve 150 is located inside the poppet chamber 125.

The soft valve 130 is installed in communication with the connection passage 111 of the port 110 so that fluid having passed through the port 110 preferentially flows through the valve housing 120.

The soft valve 130 includes a soft valve body 131, a valve disk 133, and a valve mount 135.

The soft valve body 131 is formed in a cylindrical shape, the valve mount 135 is coupled to pass through a center of the soft valve body 131, and at least one soft flow passage 132 is formed to penetrate in a circumferential direction.

The valve disk 133 is formed in a plate shape and is provided in a state of being brought into close contact with a rear end side of the soft valve body 131, for example, on a side opposite to the port 110.

The valve disk 133 may be installed in a state in which a plurality of disks are stacked.

The valve mount 135 supports the valve disk 133 and is coupled to the soft valve body 131 in a state of normally closing the soft flow passage 132.

The valve mount 135 may be provided as a rivet or a pin and may be coupled to the soft valve body 131.

The soft valve 130 is coupled to an inlet-side end of the valve housing 120 and selectively brings the port 110 and the pilot chamber 123 into communication.

In particular, since the soft valve 130 has a form of an independent component, the degree of freedom in tuning can be greatly increased through individual design to meet required specifications, for example, minimizing the damping force of the main valve in a soft mode and adjusting damping force at low speeds.

The main valve 140 is accommodated in the pilot chamber 123 of the valve housing 120 and may include a valve seat 141, a valve body 143, and a valve spring 145.

The valve seat 141 is formed in a ring shape.

In addition, the valve seat 141 may also be supported by a locking step 127 provided on an inner surface of the valve housing 120 using a stepped portion formed on an outer side of the valve seat 141.

A rear end of the valve seat 141 selectively comes into contact with a front end of the valve body 143 to bring a main flow path between the pilot chamber 123 and the valve housing into communication.

The valve body 143 is coupled to the pilot chamber 123 to be movable upward and downward.

The valve body 143 includes a body disk 143a formed in a disk shape and a front rim 143b and a rear rim 143c respectively extending forward and rearward from the body disk 143a.

The body disk 143a includes a body hole 144 at a center thereof to allow communication between a front side and a rear side of the body disk 143a.

An upper end of the front rim 143b selectively comes into contact with or is spaced apart from a rear end of the valve seat 141, and a rear end of the rear rim 143c is elastically supported toward the port side via a valve spring 145.

The valve spring 145 may have a coil spring shape.

The safety valve 150 is provided in the poppet chamber 125 and is arranged between the valve housing 120 and the solenoid 160.

The solenoid 160 is driven by current supplied from the outside, and when current is applied, an electromagnetic force generated by the excitation of a coil moves a protruding rod 162 in a front-rear direction.

In addition, a bypass flow path 170 is provided between the valve housing 120 and the solenoid 160.

The bypass flow path 170 connects an inside of the poppet chamber 125 to the reservoir chamber 15.

Specifically, the bypass flow path 170 has an inlet connected to the inside of the poppet chamber 125 and an outlet connected to the low-pressure chamber PL of the reservoir chamber 15 so that, during driving in a hard mode, a soft mode, or a fail mode, working fluid in the poppet chamber 125 is moved to the low-pressure chamber PL.

However, in the conventional damping force variable valve assembly configured as described above, since the port 110 and the soft valve 130 are provided separately, sealing must be performed between the port 110 and the soft valve body 131.

Accordingly, the number of components increases, assembly becomes complicated, and an overall size of the valve assembly becomes larger.

### SUMMARY

An object of the present disclosure is to provide a damping force variable valve assembly that allows ease of assembly and a reduction in overall size, and a damping force variable shock absorber including the same.

The objects of the present disclosure are not limited to the above-described objects, and other objects that are not mentioned will be able to be clearly understood by those skilled in the art to which the present disclosure pertains from the following description.

According to an aspect of the present disclosure, provided is a damping force variable valve assembly, comprising an integral soft valve port having a front end coupled to a shock absorber body, the integral soft valve port having a connection passage formed to penetrate in a front-rear direction such that working fluid flows therein from the shock absorber body, and having a rear portion to which a valve disk is brought into close contact; a valve housing formed in a hollow cylindrical shape, a front-end inner circumferential surface of the valve housing being coupled to an outer circumferential surface of the integral soft valve port; and a main valve disposed inside the valve housing at a rear portion of the integral soft valve port, wherein the integral soft valve port comprises a main body portion having a fitting hole formed to penetrate a central portion of the main body portion such that a valve mount fixing the valve disk is fitted into the fitting hole, and having the connection passage formed outside the fitting hole; and a sub-body portion formed to extend laterally from a rear circumference of the main body portion, a protrusion being formed on a rear surface of the sub-body portion to come into close contact with a front surface of the valve disk, wherein the connection passage is located between the fitting hole and the protrusion, and wherein the connection passage comprises a first region having a relatively small transverse cross-sectional area and a second region having a relatively larger transverse cross-sectional area than the first region and located rearward of the first region.

In this case, a first side surface of the second region, the first side surface being closer to the protrusion, may be inclined toward the protrusion.

In this case, the first side surface may be formed with an uneven shape.

Meanwhile, the first side surface may be formed as a planar surface or a curved surface.

Meanwhile, a first side surface of the second region, the first side surface being closer to the protrusion, may be formed to extend in a front-rear direction.

Meanwhile, a valve mount that fixes the valve disk may be fitted into the fitting hole.

Meanwhile, the valve disk may be provided in a form in which a plurality of disks are stacked.

Meanwhile, the valve disk may be coupled to a rear portion of the integral soft valve port in a state in which the valve disk normally closes the connection passage.

Meanwhile, the connection passage may be formed in a plurality.

Meanwhile, the sub-body portion may include a first sub-body portion formed to extend laterally along a rear circumference of the main body portion and having the protrusion formed to protrude from a rear surface of the first sub-body portion; and a second sub-body portion formed to extend rearward along a rim region of the rear surface of the first sub-body portion.

In this case, the valve disk may be located in a mounting groove surrounded by an inner circumferential surface of the second sub-body portion.

Meanwhile, support portions may protrude horizontally from an outer circumferential surface of the sub-body portion at predetermined intervals along a circumferential direction.

In this case, the support portions may be provided in three locations and are arranged at 120° intervals along a circumferential direction.

In this case, an outer circumferential surface of the support portion may be in contact with an inner circumferential surface of the valve housing, and a rear surface of the support portion may be in contact with an upper surface of the main valve, thereby allowing the integral soft valve port to remain in a stable state inside the valve housing.

Meanwhile, the connection passage formed in the main body portion may be formed in a plurality along a circumferential direction outside the fitting hole.

Meanwhile, the valve mount may be provided in a rivet shape or a pin shape.

According to another aspect of the present disclosure, a damping force variable shock absorber including the damping force variable valve assembly may be provided.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 illustrates a damping force variable shock absorber according to related art.

FIG. 2 is a view illustrating a structure of a damping force variable valve assembly employed in the damping force variable shock absorber of FIG. 1.

FIG. 3 is an enlarged view illustrating a port and a soft valve of FIG. 2.

FIG. 4 is a view illustrating a state in which a valve mount is removed from FIG. 3.

FIG. 5 is a view illustrating a damping force variable shock absorber according to the present disclosure.

FIG. 6 is a view illustrating a structure of a damping force variable valve assembly employed in the damping force variable shock absorber of FIG. 5.

FIG. 7 is an enlarged view illustrating an integral soft valve port of FIG. 6.

FIG. 8 is a view illustrating a state in which a valve mount is removed from FIG. 7.

FIG. 9 is a view illustrating a state in which a valve disk is removed from the integral soft valve port of FIG. 8.

FIG. 10 is a view illustrating an integral soft valve port according to another exemplary embodiment of the present disclosure.

FIG. 11 is a view illustrating a state in which a valve mount is removed from FIG. 10.

FIG. 12 is a modified example of a first side surface of a second region illustrated in FIG. 10.

FIG. 13 is another modified example of the first side surface of the second region illustrated in FIG. 10.

FIG. 14 is still another modified example of the first side surface of the second region illustrated in FIG. 10.

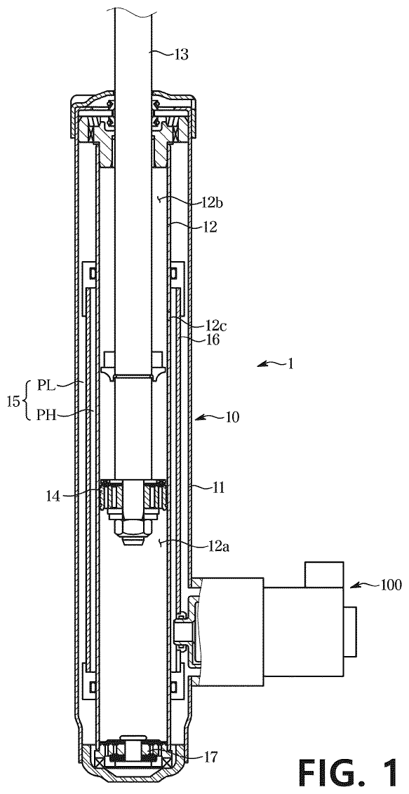

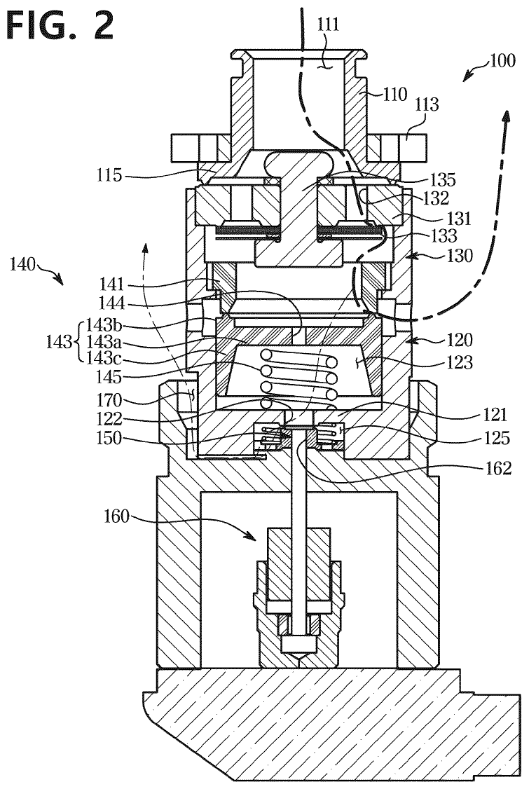

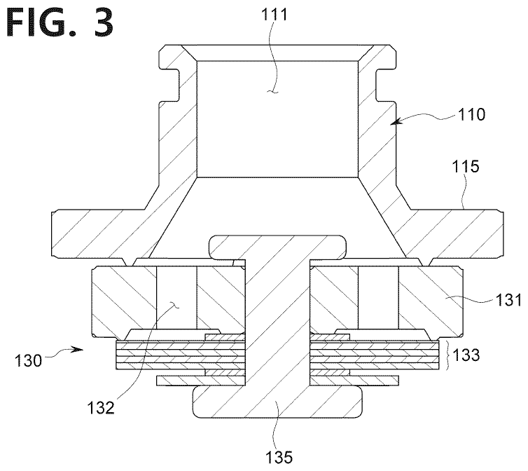

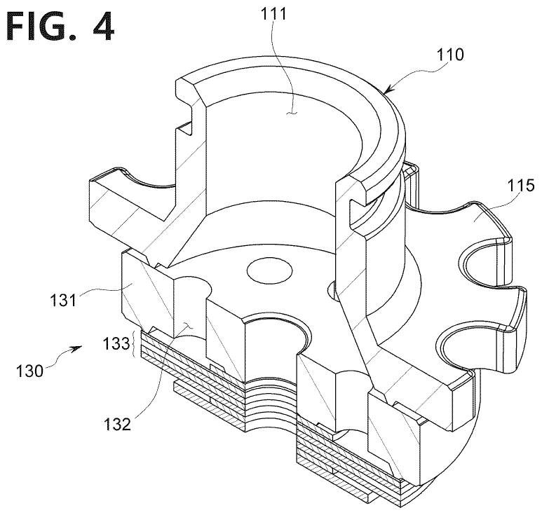

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

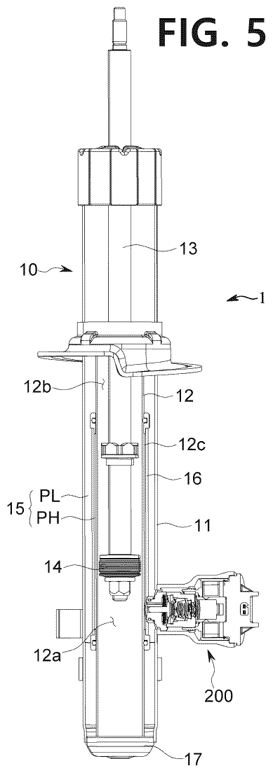

FIG. 5 is a view illustrating a damping force variable shock absorber according to the present disclosure.

The damping force variable shock absorber according to the present disclosure includes a shock absorber body 1 and a damping force variable valve assembly 200.

The shock absorber body 1 includes a cylinder 10 having an outer tube 11 and an inner tube 12, a piston rod 13, a piston valve 14, a reservoir chamber 15, and a separator tube 16.

The damping force variable valve assembly 200 is mounted on an outer side of the outer tube 11, and the inner tube 12 is installed inside the outer tube 11 to maintain a predetermined spacing.

In addition, the reservoir chamber 15 for forming a low-pressure chamber PL and a high-pressure chamber PH is formed between the outer tube 11 and the inner tube 12.

The piston rod 13 reciprocates in compression and extension stroke directions in a state in which one end thereof is coupled to the piston valve 14 located inside the inner tube 12.

The piston valve 14, in a state in which one end of the piston rod 13 is coupled thereto, divides the inner tube 12 in a longitudinal direction into a compression chamber 12a and an extension chamber 12b and generates a damping force by reciprocating in the compression and extension stroke directions inside the cylinder 10 so as to create resistance of fluid.

The reservoir chamber 15 is provided in a space between the outer tube 11 and the inner tube 12.

The separator tube 16 is provided between the outer tube 11 and the inner tube 12, and more specifically on an outer surface of the inner tube 12, so that a high-pressure chamber PH is formed on an inner side thereof and a low-pressure chamber PL is formed on an outer side thereof.

That is, the separator tube 16 partitions the inside of the reservoir chamber 15 into the low-pressure chamber PL and the high-pressure chamber PH.

A body valve 17 is installed at a lower end of the inner tube 12 and generates damping force by controlling a flow of working fluid between the reservoir chamber 15 and the compression chamber 12a.

Meanwhile, the high-pressure chamber PH is connected to the extension chamber 12b through an internal hole 12c provided in the inner tube 12, and the low-pressure chamber PL is connected to the compression chamber 12a through a lower flow path formed between the body valve 17 and the outer tube 11 and through a flow path (not shown) formed in the body valve 17.

The damping force variable valve assembly 200 is coupled to the shock absorber body 1. Working fluid can be introduced from the shock absorber body 1.

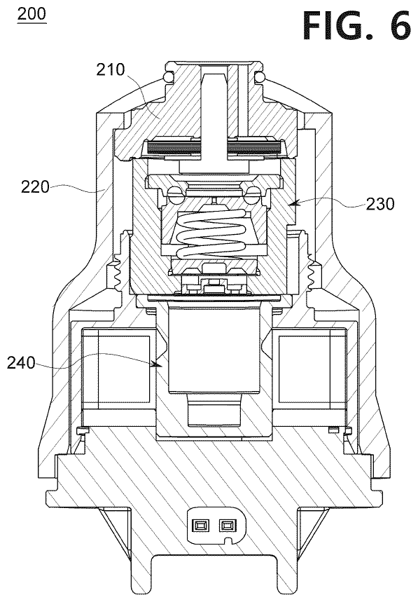

FIG. 6 is a view illustrating a structure of a damping force variable valve assembly employed in the damping force variable shock absorber of FIG. 5.

Hereinafter, when viewed from FIG. 6, a shock absorber body 1 to which the damping force variable valve assembly 200 is coupled is located above, and a direction toward the shock absorber body 1 is defined as a front side of the damping force variable valve assembly 200.

The damping force variable valve assembly 200 according to the present disclosure may include an integral soft valve port 210, a valve housing 220, a main valve 230, and a solenoid 240.

The integral soft valve port 210 has a front end connected to the shock absorber body 1 illustrated in FIG. 5, a connection passage 211b is formed to penetrate the interior so that working fluid from the shock absorber body 1 can be introduced, and a valve disk 217 is brought into close contact with a rear portion thereof.

The front end of the integral soft valve port 210 is connected to the high-pressure chamber PH through the outer tube 11 and the separator tube 16 illustrated in FIG. 5. At this time, working fluid from the high-pressure chamber PH may be introduced into the integral soft valve port 210 through the connection passage 211b extending in a front-rear direction in the integral soft valve port 210.

A fitting hole 211a may be formed to penetrate the center of the integral soft valve port 210, and the fitting hole 211a may extend in a front-rear direction.

A valve mount 219 formed in a rivet or pin shape may be fitted into the fitting hole 211a to fix the valve disk 217. In this case, the valve mount 219 may pass through a center of the valve disk 217 and be inserted into the fitting hole 211a to be coupled to the integral soft valve port 210.

Furthermore, the valve disk 217 may be coupled to a rear portion of the integral soft valve port 210 in a state of normally closing the connection passage 211b formed in the integral soft valve port 210.

In addition, the connection passage 211b of the integral soft valve port 210 may be formed in a plurality.

The valve housing 220 is formed in a hollow cylindrical shape, and an inner circumferential surface of a front end portion thereof is coupled to an outer circumferential surface of the integral soft valve port 210.

The main valve 230 is disposed inside the valve housing 220 at a rear portion of the integral soft valve port 210.

The integral soft valve port 210 of the damping force variable valve assembly 200 according to the present disclosure integrates a port and a soft valve of a conventional damping force variable valve assembly, thereby facilitating assembly and reducing an overall size of the valve assembly 200.

In the damping force variable valve assembly 200 according to the present disclosure, descriptions of remaining components such as the valve housing 220, the main valve 230, and the solenoid 240, except for the integral soft valve port 210, will be omitted since they are identical to those of the related art.

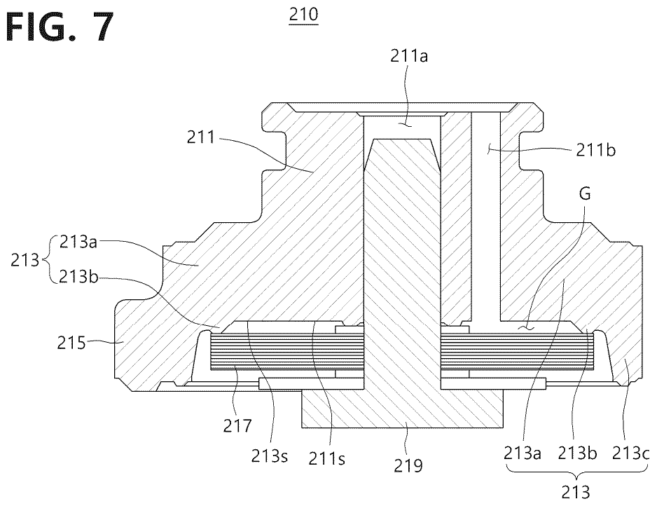

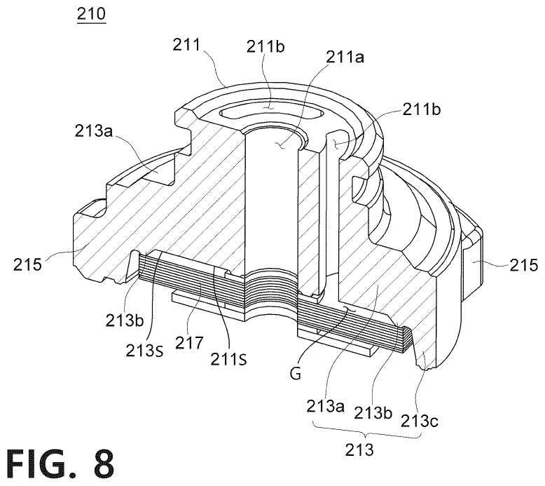

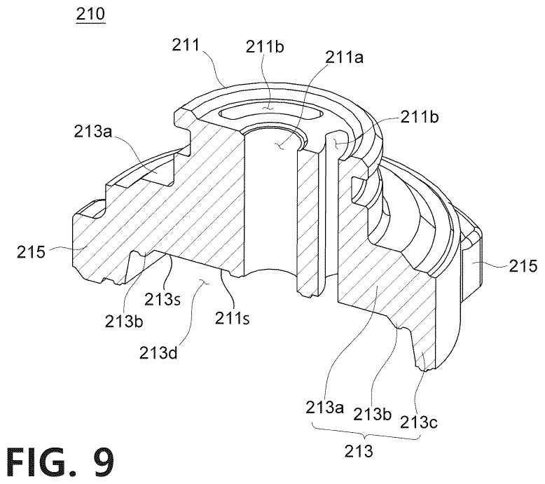

FIG. 7 is an enlarged view illustrating an integral soft valve port of FIG. 6, FIG. 8 is a view illustrating a state in which a valve mount is removed from FIG. 7, and FIG. 9 is a view illustrating a state in which a valve disk is removed from the integral soft valve port of FIG. 8.

The integral soft valve port 210 may include a main body portion 211, a sub-body portion 213, a support portion 215, a valve disk 217, and a valve mount 219.

The main body portion 211 is formed in a disk shape having a predetermined thickness, a fitting hole 211a into which the valve mount 219 formed of a pin, a rivet, or the like is fitted to fix the valve disk 217 is formed to penetrate a center thereof, and a connection passage 211b is formed outside the fitting hole 211a.

In this case, the connection passages 211b formed in the main body portion 211 may be formed in a plurality along a circumferential direction on an outer side of the fitting hole 211a.

The sub-body portion 213 has a predetermined thickness and extends laterally along a rear circumference of the main body portion 211. A protrusion 213b brought into close contact with a front surface of the valve disk 217 is formed on a rear surface 213s of the sub-body portion 213.

The protrusion 213b may come into close contact with a rim of a front surface of the valve disk 217. The connection passage 211b may be located between the fitting hole 211a and the protrusion 213b.

The sub-body portion 213 may include a first sub-body portion 213a that extends laterally along a rear circumference of the main body portion 211 and on which a protrusion 213b is formed to project from a rear surface 213s, and a second sub-body portion 213c that extends rearward along a rim region of the rear surface of the first sub-body portion 213a.

The rear surface 211s of the main body portion 211 and the rear surface 213s of the first sub-body portion 213a are preferably located on a same plane.

The second sub-body portion 213c is disposed outward of the protrusion 213b from the rear surface 213s of the first sub-body portion 213a. The second sub-body portion 213c protrudes farther rearward from the rear surface 213s of the first sub-body portion 213a than the protrusion 213b.

A gap space G communicating with the connection passage 211b is formed between the rear surfaces 211s and 213s of the main body portion 211 and the first sub-body portion 213a and a front surface of the valve disk 217, while the protrusion 213b forms part of the gap space G.

Through the connection passage 211b, working fluid may flow into the gap space G, and when the pressure of the working fluid in the gap space G reaches or exceeds a predetermined value, the valve disk 217 is deformed and separated from the protrusion 213b so that the working fluid may be discharged from the gap space G.

Furthermore, the valve disk 217 may be located in a mounting groove 213d formed between an inner circumferential surface of the second sub-body portion 213c and the rear surfaces 211s and 213s of the main body portion 211 and the first sub-body portion 213a.

Furthermore, support portions 215 may protrude laterally at predetermined intervals along a circumferential direction on an outer circumferential surface of the second sub-body portion 213c.

The support portions 215 are preferably provided in three locations and are arranged at 120° intervals along the circumferential direction.

In this case, an outer circumferential surface of the support portion 215 comes into contact with an inner circumferential surface of the valve housing 220, and a rear surface of the support portion 215 comes into contact with a front surface of the main valve 230, thereby allowing the integral soft valve port 210 to remain in a stable state inside the valve housing 220.

By providing the support portions 215 in the minimum required number, durability can be maintained while manufacturing costs, including mold costs, can be reduced.

The valve disk 217 may be provided in a form in which a plurality of plate-shaped disks are stacked.

In the valve disk 217, a through-hole (not shown) penetrating in a front-rear direction is formed at a central portion so that the valve mount 219 formed of a pin, a rivet, or the like is fitted therein.

The valve mount 219 may be fitted into the fitting hole 211a formed in the main body portion 211 and into the through-hole (not shown) formed in the valve disk 217.

As such, the present disclosure provides the integral soft valve port 210 in which the conventional port and soft valve are integrated, thereby facilitating assembly and reducing an overall size of the valve assembly 200.

Accordingly, the present disclosure can cope with recent demands in the automobile industry for simplifying not only suspension systems but also steering and driveline structures, and for reducing damper size in response to requirements for improved ride comfort, enhanced steering stability, and increased interior space.

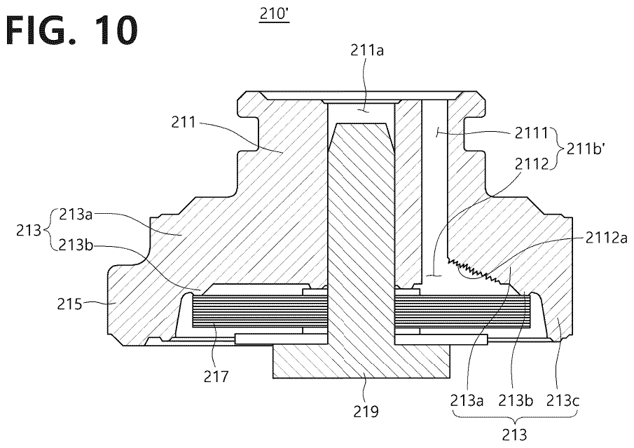

FIG. 10 is a view illustrating an integral soft valve port according to another exemplary embodiment of the present disclosure, and FIG. 11 is a view illustrating a state in which a valve mount is removed from FIG. 10.

Referring to FIGS. 10 and 11, an integral soft valve port 210′ according to the present embodiment includes a main body portion 211 and a sub-body portion 213.

A fitting hole 211a, into which a valve mount 219 that fixes the valve disk 217 is fitted, is formed to penetrate a center of the main body portion 211, and a connection passage 211b′ is formed outside the fitting hole 211a.

The sub-body portion 213 is formed to extend laterally from a rear circumference of the main body portion 211, and a protrusion 213b that comes into close contact with a front surface of the valve disk 217 is formed on a rear surface of the sub-body portion 213. The connection passage 211b′ is located between the fitting hole 211a and the protrusion 213b.

The sub-body portion 213 may include a first sub-body portion 213a that extends laterally along a rear circumference of the main body portion 211 and on which a protrusion 213b is formed to project from a rear surface, and a second sub-body portion 213c that extends rearward along a rim region of the rear surface of the first sub-body portion 213a.

The integral soft valve port 210′ according to the present embodiment is substantially identical to the integral soft valve port 210 illustrated in FIGS. 7 and 8, except for the shape of the connection passage 211b′ and portions associated therewith, and thus a detailed description thereof will be omitted.

Hereinafter, in describing the integral soft valve port 210′ according to the present embodiment, the description will focus on the connection passage 211b′.

In the present embodiment, the connection passage 211b′ is formed to extend in a front-rear direction in the main body portion 211. The connection passage 211b′ includes a first region 2111 having a relatively small cross-sectional area and a second region 2112 having a larger cross-sectional area than the first region 2111 and located rearward of the first region 2111.

Here, a transverse section of the connection passage 211b′ refers to a section taken in a direction perpendicular to a front-rear extension direction of the connection passage 211b′.

The second region 2112 is a region closer to the valve disk 217 than the first region 2111.

The first region 2111 may be formed to have a constant transverse cross-sectional area along the extension direction of the connection passage 211b′.

The second region 2112 may have a shape in which a transverse cross-sectional area increases along an extension direction of the connection passage 211b′. Due to the second region 2112, working fluid flowing toward the valve disk 217 through the connection passage 211b′ is uniformly distributed from a central portion of the valve disk 217 to a rim region distant from the center. In this case, the hydraulic pressure of the working fluid can act uniformly over an entire area of the valve disk 217.

In this case, deformation of the valve disk 217 can be achieved with a relatively small hydraulic pressure, unlike in a case in which the connection passage 211b′ has a constant transverse cross-sectional area in the front-rear direction, thereby improving efficiency.

A first side surface 2112a of the second region 2112, which is closer to the protrusion 213b, may be formed to slope toward the protrusion 213b, as shown in FIGS. 10 and 11. In this case, the first side surface 2112a of the second region 2112 may have an uneven shape.

For example, as shown in FIGS. 7 and 8, the first side surface 2112a of the second region 2112, which slopes toward the protrusion 213b and has an uneven shape, may be formed by grinding rear surfaces 211s and 213s of the main body portion 211 and the first sub-body portion 213a, respectively, the rear surfaces being located on the same plane, through a sintering process.

The first side surface 2112a of the second region 2112 may be formed across the main body portion 211 and the first sub-body portion 213a, as shown in FIGS. 10 and 11. The first side surface 2112a of the second region 2112 constitutes rear surfaces of the main body portion 211 and the first sub-body portion 213a. However, although not illustrated, the first side surface of the second region may be formed only on the main body portion.

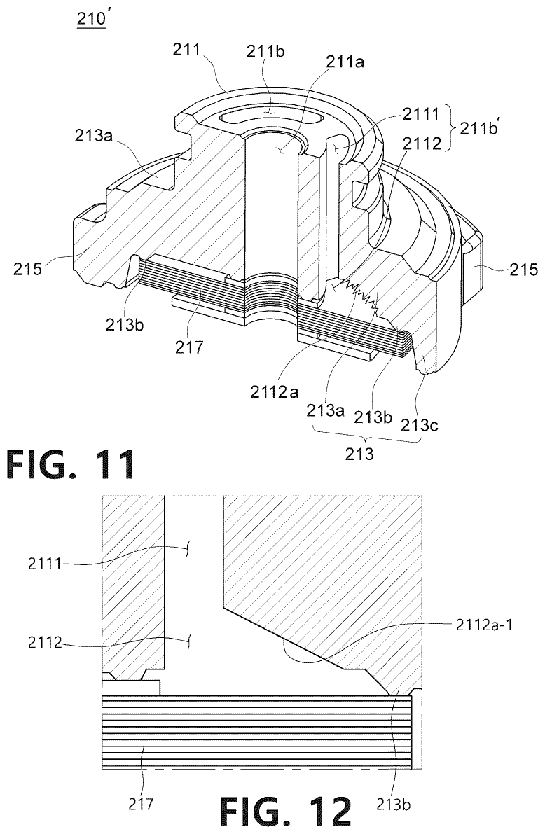

Alternatively, first side surfaces 2112a-1 and 2112a-2 of the second region 2112, which are closer to the protrusion 213b, may be formed to slope toward the protrusion 213b, as shown in FIGS. 12 and 13. In this case, the first side surface 2112a-1 of the second region 2112 may have a planar shape as shown in FIG. 12, or may have a curved shape as shown in FIG. 13. The first side surface 2112a-2 in the curved shape may have a convex shape in a forward direction, as shown in FIG. 13, or a convex shape in a rearward direction, although not illustrated.

For reference, FIG. 12 illustrates one modified example of the first side surface of the second region shown in FIG. 10, and FIG. 13 illustrates another modified example of the first side surface of the second region shown in FIG. 10.

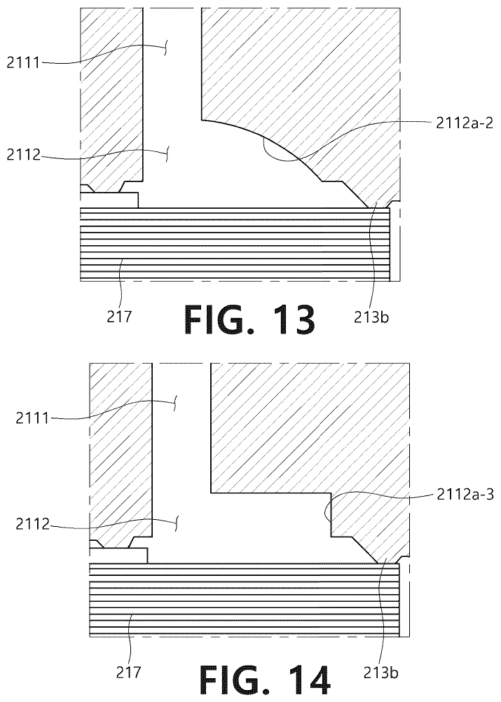

Alternatively, a first side surface 2112a-3 of the second region 2112, which is closer to the protrusion 213b, may be formed to extend in a front-rear direction, as shown in FIG. 14. Stated differently, the first side surface 2112a-3 of the second region 2112 may be formed to extend in a direction perpendicular to a front surface of the valve disk 217, as shown in FIG. 14. In this case, a front inner surface of the second region 2112 may be formed to be parallel to the front surface of the valve disk 217.

For reference, FIG. 14 illustrates still another modified example of the first side surface of the second region shown in FIG. 10.

The damping force variable valve assembly according to an exemplary embodiment of the present disclosure provides an integral soft valve port in which a conventional port and a soft valve are integrated, thereby facilitating assembly and reducing an overall size of the valve assembly.

Accordingly, the present disclosure can cope with recent demands in the automobile industry for simplifying not only suspension systems but also steering and driveline structures, and for reducing damper size in response to requirements for improved ride comfort, enhanced steering stability, and increased interior space.

Furthermore, because the second region of the connection passage, which has a larger transverse cross-sectional area than the first region and is closer to the valve disk, has a shape in which the transverse cross-sectional area increases along an extension direction of the connection passage, working fluid flowing toward the valve disk through the connection passage is uniformly distributed from a central portion of the valve disk to a rim region distant from the center, and hydraulic pressure of the working fluid can act uniformly over an entire area of the valve disk.

Accordingly, deformation of the valve disk can be achieved with a relatively small hydraulic pressure as compared with a case in which the connection passage has a constant transverse cross-sectional area in the front-rear direction, thereby improving efficiency.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A damping force variable valve assembly, comprising:
an integral soft valve port having a front end coupled to a shock absorber body, the integral soft valve port having a connection passage formed to penetrate in a front-rear direction such that working fluid flows therein from the shock absorber body, and having a rear portion to which a valve disk is brought into close contact;
a valve housing formed in a hollow cylindrical shape, a front-end inner circumferential surface of the valve housing being coupled to an outer circumferential surface of the integral soft valve port; and
a main valve disposed inside the valve housing at a rear portion of the integral soft valve port,
wherein the integral soft valve port comprises:
a main body portion having a fitting hole formed to penetrate a central portion of the main body portion such that a valve mount fixing the valve disk is fitted into the fitting hole, and having the connection passage formed outside the fitting hole; and
a sub-body portion formed to extend laterally from a rear circumference of the main body portion, a protrusion being formed on a rear surface of the sub-body portion to come into close contact with a front surface of the valve disk,
wherein the connection passage is located between the fitting hole and the protrusion, and
wherein the connection passage comprises a first region having a relatively small transverse cross-sectional area and a second region having a relatively larger transverse cross-sectional area than the first region and located rearward of the first region.

2. The damping force variable valve assembly of claim 1, wherein a first side surface of the second region, the first side surface being closer to the protrusion, is inclined toward the protrusion.

3. The damping force variable valve assembly of claim 2, wherein the first side surface is formed with an uneven shape.

4. The damping force variable valve assembly of claim 2, wherein the first side surface is formed as a planar surface or a curved surface.

5. The damping force variable valve assembly of claim 1, wherein a first side surface of the second region, the first side surface being closer to the protrusion, is formed to extend in a front-rear direction.

6. The damping force variable valve assembly of claim 1, wherein a valve mount that fixes the valve disk is fitted into the fitting hole.

7. The damping force variable valve assembly of claim 1, wherein the valve disk is provided in a form in which a plurality of disks are stacked.

8. The damping force variable valve assembly of claim 1, wherein the valve disk is coupled to a rear portion of the integral soft valve port in a state in which the valve disk normally closes the connection passage.

9. The damping force variable valve assembly of claim 1, wherein the connection passage is formed in a plurality.

10. The damping force variable valve assembly of claim 1, wherein the sub-body portion comprises:
a first sub-body portion formed to extend laterally along a rear circumference of the main body portion and having the protrusion formed to protrude from a rear surface of the first sub-body portion; and
a second sub-body portion formed to extend rearward along a rim region of the rear surface of the first sub-body portion.

11. The damping force variable valve assembly of claim 10, wherein the valve disk is located in a mounting groove surrounded by an inner circumferential surface of the second sub-body portion.

12. The damping force variable valve assembly of claim 1, wherein support portions protrude horizontally from an outer circumferential surface of the sub-body portion at predetermined intervals along a circumferential direction.

13. The damping force variable valve assembly of claim 12, wherein the support portions are provided in three locations and are arranged at 120° intervals along a circumferential direction.

14. The damping force variable valve assembly of claim 13, wherein an outer circumferential surface of the support portion is in contact with an inner circumferential surface of the valve housing, and a rear surface of the support portion is in contact with an upper surface of the main valve, thereby allowing the integral soft valve port to remain in a stable state inside the valve housing.

15. The damping force variable valve assembly of claim 1, wherein the connection passage formed in the main body portion is formed in a plurality along a circumferential direction outside the fitting hole.

16. The damping force variable valve assembly of claim 1, wherein the valve mount is provided in a rivet shape or a pin shape.

17. A damping force variable shock absorber comprising the damping force variable valve assembly according to claim 1.
